(19) United States
(12) Patent Application Publication
(10) Pub. No.: US 2003/0014310 A1
(43) Pub. Date: Jan. 16, 2003

(54) Method of providing multimedia files combined with advertisements over the internet

(76) Inventors: June Kee Jung, Seoul (KR); Gi Hoon Keum, Seoul (KR); Soung Hong Kim, Seoul (KR); Ji Hoon Lee, Seoul (KR); Jung Sam Kim, Chungscheung Buk-Do (KR)

Correspondence Address: VOLPE AND KOENIG, P.C., SUITE 400, ONE PENN CENTER, 1617 JOHN F. KENNEDY BOULEVARD, PHILADELPHIA, PA, 19103, US

(21) Appl. No.: 10/182,301

(22) PCT Filed: Jan. 10, 2001
(86) PCT No.: PCT/KR01/00028

(30) Foreign Application Priority Data
Feb. 1, 2000 (KR) 2000/4847
Nov. 17, 2000 (KR) 2000/68358

(51) Int. Cl. G06F 17/60

(52) U.S. Cl. 705/14

(57) ABSTRACT

The present invention relates to a method of providing multimedia files combined with advertisements over the internet. The present invention enables users to download multimedia files free or at low cost and advertisement agents to advertise effectively, by supplying multimedia files such as music files, video files, etc with advertisement files to users and making the users see or hear the advertisements as playing the multimedia files. The advertisements can be played as being downloaded as well as after being downloaded because they comprise audio, text, or video contents.

### TECHNICAL FIELD

The present invention relates to a method for providing multimedia files combined with advertisements over internet, and in particular, to a method for providing multimedia files, such as MP3 files, combined with advertisement files over internet by means of a web server so as to enable a user to avail of multimedia files at low costs or free of charge in exchange of listening to or viewing advertisements attached to the multimedia files.

### BACKGROUND ART

With the recent development of digital technology and data compressing technology, technology of compressing music or image digital data are rapidly being developed. Moreover, methods for reproducing music or image by transmitting and downloading compressed digital data are widely applied. Such music or image multimedia files are in a variety of formats including MP3, mp4, dat, avi, aac, ra, rm, mid, sgf, mov, mpg, vob, wav, rjs, dvd, ram, wma, asf, etc. In particular, the technology of downloading MP3 files over internet and reproducing the downloaded MP3 files by means of an MP3 player is rapidly spread owing to the convenience of its use.

Music or image files used to be provided for users free of charge in the form of downloading over a network. In recent days, however, such files are being provided at a certain cost for paying copyright-related expenses.

Of the numerous music or image multimedia files, MP3 files are replacing magnetic tapes or compact discs (CD) with the development of an MP3-exclusive player (i.e., an MP3 player). Provision of music through the MP3 file player has eliminated the user inconveniences of downloading undesired music by realizing a convenient download of desired music only. However, a considerable amount of expense must be paid whenever downloading a music file. The expense, paid per a music file, is higher than what is incurred for ordinary storing media (e.g., a magnetic tape or a CD), thereby posing financial burden on the user. For this reason, most of the electronic commerce of the digital contents are conducted in the form of unauthorized copying.

### DISCLOSURE OF INVENTION

It is, therefore, an object of the present invention to provide multimedia files combined with advertisement files when downloading multimedia files such as MP3 files to publicly spread digital contents by supplying to a user multimedia files at low cots or free of charge in exchange of listening or viewing advertisements as well as by supplying to advertisers a method for internet contents provision which can enhance effect of advertisements.

To achieve the above objects, there is provided a method for providing multimedia files over internet in response to a request by a user according to one aspect of the present invention, comprising the steps of: determining a propensity of a user based on a multimedia file requested by the user; selecting an advertisement file based on the propensity of the user and information thereon, and combining the selected advertisement file with the multimedia file requested by the user; and providing the user with the combined file.

Here, the multimedia file includes a music file or dynamic image file made in diverse formats such as MP3, mp4, dat, avi, aac, ra, rm, mid, sgf, mov, mpg, vob, wav, rjs, dvd, ram, wma, asf, gif, jpg, bmp, etc. The advertisement file includes a sound file, character file, image file or a dynamic image file. The information on the user includes sex, age, address, talents, hobbies and interest. The propensity of the user is determined by reference to the characteristic features of the contents contained in the multimedia file requested by the user including a genre of the contents, year of manufacturing the contents, name of the composer or the singer.

The method according to the present invention further comprises a step of downloading a multimedia file combined with the advertisement file. While the user is downloading the multimedia file combined with the advertisement file, the advertisement file can be reproduced by streaming.

The method according to the present invention further comprises a step of reproducing the downloaded fie with a reproducing device including a portable reproducer or a computer by the user. When reproducing the advertisement file contained in the downloaded file, the uniform resource locator (URL) related to the advertisement file may be displayed.

Also, when the advertisement file contained in the downloaded file is reproduced for the first time, the information on the reproducing device may be added to the downloaded file. When the downloaded file is later reproduced by another reproducing device, the advertisement file contained in the downloaded file can be always reproduced simultaneously with the downloaded file by reference to the information on the original reproducing device.

After repeated reproduction of predetermined times or after elapse of a predetermined period of time, the advertisement file may be no longer reproduced even when the downloaded file is being reproduced. To limit reproduction of the advertisement file to predetermined times, information showing the reproducing times of the advertisement file may be included in a header of the multimedia file. To limit reproducing time of the advertisement file to a predetermined period, information showing the period of reproducing time may be included in the header of the multimedia file.

Also, the advertisement file may be deleted from the downloaded file after repeated reproduction of predetermined times or after elapse of a predetermined period of time.

The method according to the present invention further comprises a step of generating a multimedia file providing order by calculating the times provided for the user. The multimedia file providing order may be provided for an advertiser, a music disc production companies or for broadcasting companies.

The selection of an advertisement file may be made with reference to a fiscal year, quantity or a target or advertisements.

The method for providing multimedia files over internet in response to a request by a user according to another aspect of the present invention comprises the steps of: analyzing inclination of the user based on the multimedia file requested by the user; selecting an advertisement file bawds on the inclination of the user and the information thereon, and combining the selected advertisement file with the multimedia file requested by the user; adding the information for the user to the combined file; and providing the user with the combined file to which the information has been added.

The information for the user includes a serial number, times to be reproduced, times reproduced, code number of the singer, sex of the singer, country code number, the year when the song was published, and the first implemented date.

The method for providing multimedia files according to the present invention may be realized through wireless internet.

### BRIEF DESCRIPTION OF DRAWINGS

The above and other objects, features and advantages of the present invention will become more apparent from the following detailed description when taken in conjunction with the accompanying drawings, in which:

FIG. 1 is a block diagram illustrating an order of downloading an MP3 file combined with an advertisement over internet by a user;

FIG. 2 is a table exemplifying designation of classifying codes in accordance with genre of music;

FIG. 3 is an example of a web page displaying a URL of an advertisement reproduced simultaneously with a download multimedia file;

FIG. 4 is a block diagram illustrating an order of reproducing an advertisement predetermined times; and

FIG. 5 is a block diagram illustrating an order of reproducing an advertisement for a predetermined period of time.

### BEST MODES FOR CARRYING OUT THE INVENTION

Best modes for carrying out the present invention will be described herein below with reference to the accompanying drawings. In the following description, well-known functions or constructions are not described in detail since they would obscure the invention in unnecessary detail.

A best mode 1 is the case of providing a music service over internet, particularly of providing an MP3 file over internet.

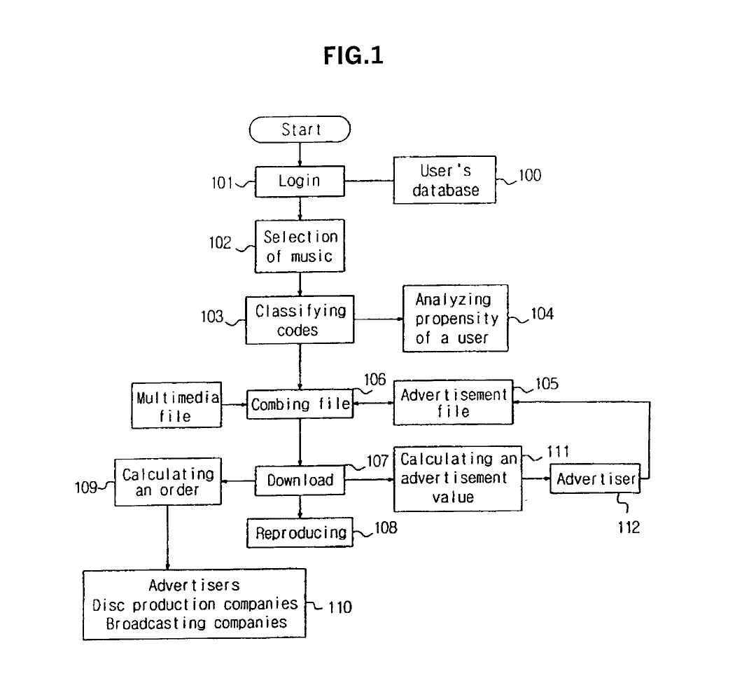

FIG. 1 is a block diagram illustrating an order of downloading an MP3 file combined with an advertisement over internet by a user.

In general, a multimedia file according to the present invention is provided through a relevant home page. As shown in FIG. 1, the user accesses the corresponding home page over internet, and inputs his/her own ID and password to log in (step 101). Subscription to a membership by the user should precede logging in. The subscription to a membership requires an input of diverse personal information including the name, address and date of birth of the user, talents, hobbies, interest, etc. The information on the user is stored in the user's database of a web server (step 100) so as to provide the user with appropriate advertisement.

Even though it is a general practice to provide files for subscribed users who access the corresponding home page, the files may be provided for non-subscribed users as well. Considering the service provision for user, however, it is preferable to provide the files for the subscribed users only.

Once the user logs in as shown in FIG. 1, the user's computer transmits his/her own ID and password to the web server. The web server then searches the user's database (step 100) so as to recognize diverse data corresponding to the transmitted user's ID.

Subsequently, the web server transmits a web page to the user's computer for the user's selection of a title of music. Then, the user can select a desired music (step 102) by first selecting a desired genre of music. Thereafter, the user may select any one of diverse titles pertinent to the genre, or may conduct searches by inputting a desired title of music, a name of the composer/songwriter or a name of the singer to a search window.

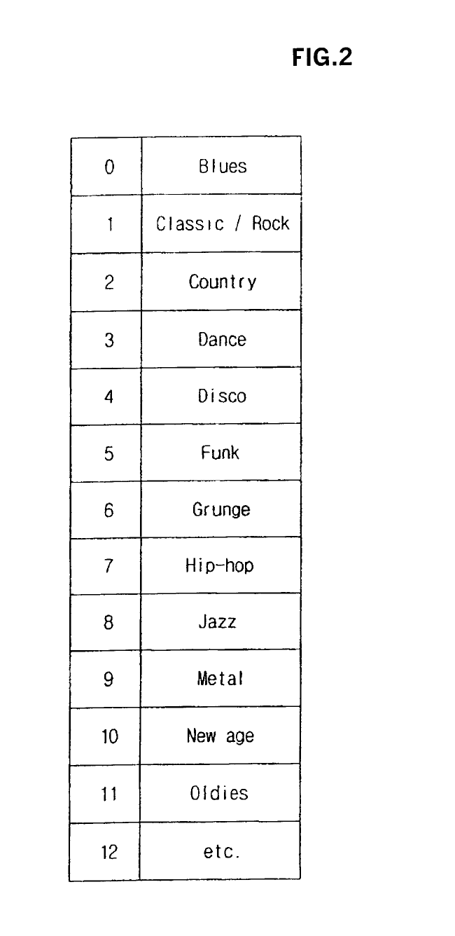

Meanwhile, classifying codes corresponding to each title of music are stored in the database of music titles (not shown in the drawing) along with the data of each music title. The classifying code is a value representing characteristics of the pertinent music. For example, a classifying code is generated by reference to diverse standards such as genre, year when the music was produced, name of the composer, name of the singer, etc (step 103). FIG. 2 shows an example of classifying codes from 0 to 12 in accordance with genre of music such as blues, classic, rock, country, dance, disco, funk, grunge, hip-hop, jazz, metal, new age, oldies, etc. The reason for using the classifying codes is as follows. If advertisements are plural with respect to a single product (for instance, the advertisements for Samsung “Anycall” are more than five, and the advertisements for Haitai “Brovo cone” are more than ten), and if the genre of the music desired by the user is new age, it is preferable to combine an advertisement file containing new age music as background music with an MP3 file. If the genre of music desired by the user is dance, it is preferable to combine an advertisement file containing speedy music as background music with an MP3 file. Thus, such classifying codes are used to select an advertisement suitable for the music desired by the user.

If the user selects a desired title of music, the web server reads in the corresponding classifying code from the database of music titles, stores the read-in classifying code in the data of the user's database (step 100), and analyzes the propensity of the user based on the classifying code (step 104).

Thereafter, the web server selects an advertisement file suitable for the user based on the propensity and information on the user stored in the user's database (step 105).

Here, the information on the user stored in the user's database (step 100) is used for determining whether or not the user corresponds to a target of a particular advertise because an advertiser designates a particular region, a particular age range and a particular sex as an advertisement target, and combines his/her advertisement with the files downloaded by the users corresponding to the target.

For example, if an advertiser designated males aged between 20 and 25 residing in Seoul as a target of an advertisement, and a male aged 22 residing in Seoul is downloading an MP3 file, the advertiser's advertisement can be combined with the MP3 file selected by the user irrespective of the kind of MP3 file the user has selected. Thus, even if two males of twenties and thirties have simultaneously downloaded the same music, they will listen to different advertisements. Therefore, the advertisement is able to effectively advertise by aiming a narrower target.

The web server combines the advertisement file selected based on the propensity of the user as well as on the information on the user stored in the user's database with the MP3 file requested by the user to be downloaded (step 106). If the user clicks a downloaded button, a dialog box is displayed so as to request the user to designate a location for storing the MP3 file that is downloaded. If the user inputs a location and a name of the file for storing the mP3 file, the MP3 file combined with the advertisement begins to be downloaded (step 107).

Downloading of a file is conducted by paying a fee or free of charge. In case of paying a fee, the fee is charged for downloading of each file so as to reduce the downloading fee in comparison with the conventional method because the advertiser provides an advertisement fee for an MP3 file supplier for an advertisement combined with the MP3 file, and the MP3 file supplier can reduce the downloading cost for the user in proportion to the advertisement fee.

Whenever a file is downloaded, the number of downloading is counted and recorded. According to the number of downloading, an order of popularity is ranged in case of music files such as MP3 files (step 109). The order of popularity may be provided for the advertiser, disc production companies or to broadcasting companies (step 110).

The number of downloading means a number of listening to or viewing an advertisement by a user, thereby being useful as a signpost of an advertisement value. The advertisement value calculated according to the number of downloading (step 111) is provided for the advertiser, so that the advertiser can accurately evaluate his/her own advertising effect and determine whether or not the paid advertisement costs are reasonable (step 112).

The advertisements such as sound, characters, image or dynamic image combined with MP3 files can be reproduced in real time while the MP3 files are downloaded (a streaming service). Also, the advertisements may be reproduced by means of a computer or a portable MP3 player upon termination of the downloading. Accordingly, the advertising effects are duplicated.

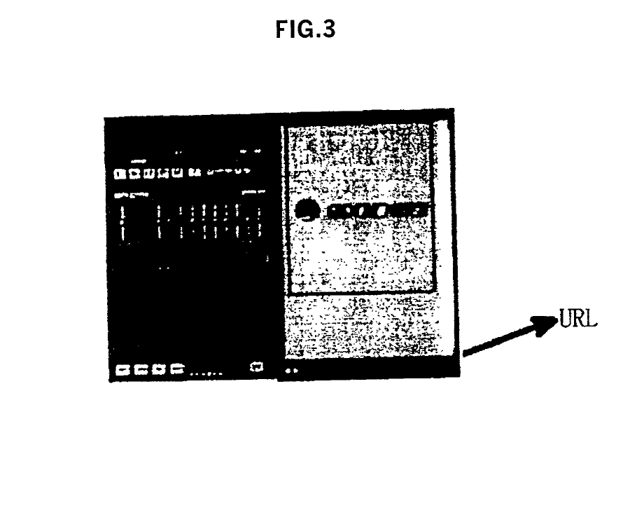

The point of time when an advertisement is reproduced may be before, in the middle or after the music is reproduced. In the middle of reproducing the advertisement, an URL of the advertisement may be displayed on a screen as shown in FIG. 3)

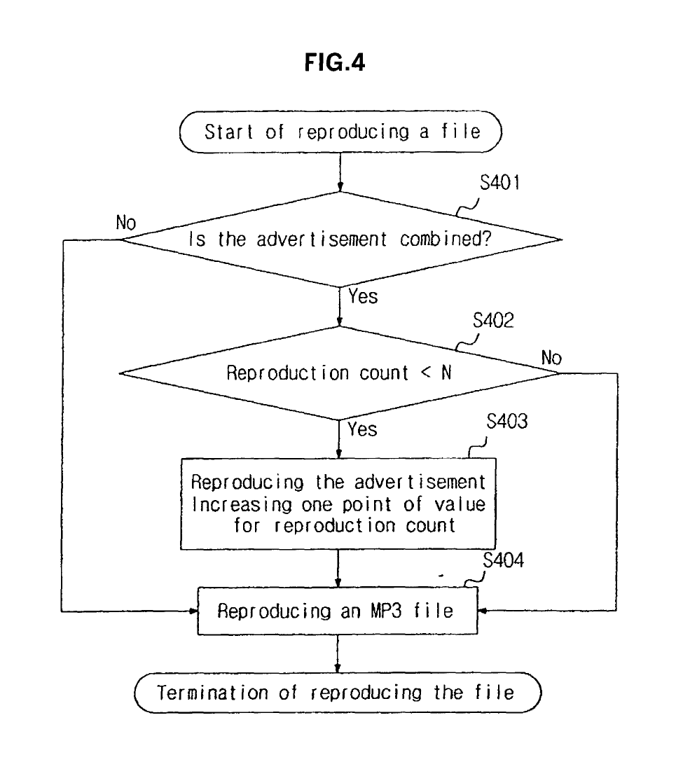

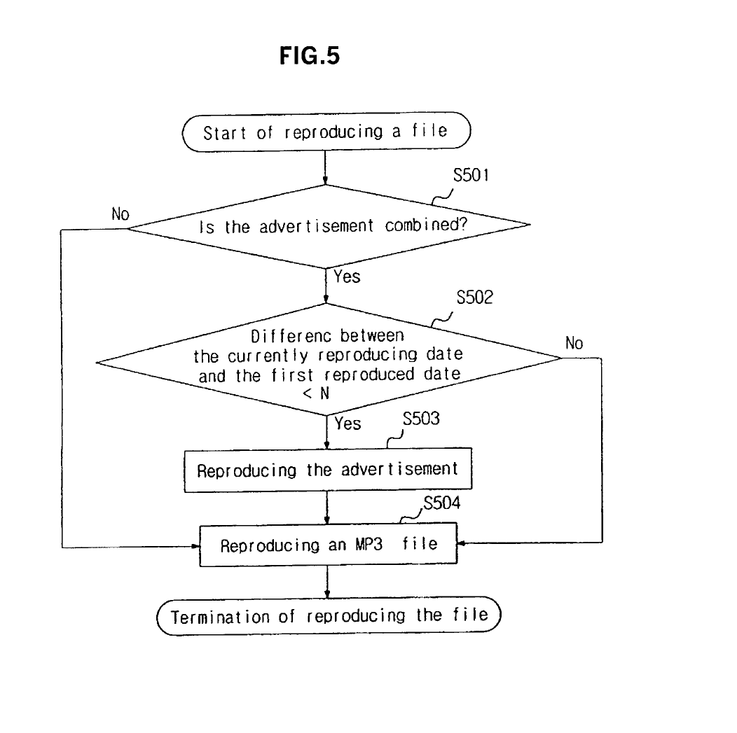

The user may feel bored if destined to listen to an advertisement whenever listening to an MP3 file. Therefore, the reproduction of an advertisement may be limited to a predetermined number of times or to a predetermined period of time. Also, if necessary, the advertisement file may be deleted. The following is a detailed description of a case made with reference to FIGS. 4 and 5 when an advertisement is reproduced a predetermined number of times or during a predetermined time.

The first description pertains to a case when an advertisement is reproduced a predetermined number of times as shown in FIG. 4. In order to reproduce an advertisement a predetermined number of times, a variable such as a reproduction count is required to store the number of reproduced times up to the present. This variable value is stored in a 4-byte header of an MP3 file with the initializing value set to be 0. As shown in FIG. 4, once an MP3 file begins to be reproduced, it is determined whether or not an advertisement is combined with the MP3 file (step 401). In the affirmative, it is checked whether or not the reproduction count is smaller than a predetermined number N (N is a natural number) of reproduced times. In the affirmative, the MP3 file is reproduced (step 404) after reproducing the advertisement and increasing one point of value of the reproduction count (step 403). If the reproduction count is equal to or greater than the predetermined number N of reproducing times, it means that the advertisement has been reproduced as many as the predetermined number of times. Therefore, the MP3 file only is reproduced without reproducing the advertisement (step 404).

The next description pertains to a case when an advertisement is reproduced for a predetermined period of time. In order to reproduce an advertisement for a predetermined period of time, it is required to store the date when the advertisement was first reproduced. As shown in FIG. 5, once an MP3 file begins to be reproduced, it is determined whether or not an advertisement is combined with the MP3 file (step 501). In the affirmative, it is checked whether or not a difference between the date when the file is currently reproduced and the date when the file was first reproduced is smaller than a predetermined reproducing period of time N (N is a natural number). In the affirmative, the advertisement is reproduced (step 503), and the MP3 file is reproduced (step 504). In the negative, it is determined that a predetermined period of time has been elapsed from the date when the file was first reproduced. Therefore, the MP3 file is directly reproduced without reproducing the advertisement (step 504).

The following is a description of a complete vanishing ratio of an advertisement combined with a multimedia file.

In general, an advertising period of time is determined to be a predetermined period of time. Therefore, it is necessary to determine the account settling period for each advertisement when a contract is to be concluded between an advertisement agent and an advertiser. In other words, it is necessary to determine until when the advertisements should be vanished between an advertisement agent and an advertiser at the time of concluding an agreement. The account settling period differs in each advertisement. Since each advertiser targets different users, and there exist numerous advertisers, multiple advertisements are applicable to one user.

Thus, if multiple advertisements are applicable to one user, it is problematic how to provide the advertisements for the one user in which ratio (i.e., an advertisement vanishing ratio). The advertisement vanishing ratio is determined depending on the construction ratio of advertisement targets of the advertisers as well as on the number of advertising times and an account settling period.

For instance, assume that an advertiser A has set a person engaged in a legal field as an advertising target, and an advertiser B has set a male as an advertising target, and an advertiser C has set a person residing in Seoul as an advertising target. If an adult having a surname Kim is engaged in a legal field and residing in Seoul, the adult becomes advertisement targets of A, B and C at the same time. Without considering the account settling period or the quantity of advertisements, each ratio of providing advertisements A, B and C to Mr. Kim is 1/3, respectively. However, if the vanishing period of time for advertisements A, B and C are within 1 month, within 3 months and within 3 months, respectively, and the quantity of advertisement is the same (i.e., if all the advertisers of the advertisements A, B and C uniformly desire 100,000 times of advertisements), the ratio of providing the advertisements A should be three times the ratio of providing the other advertisements. Therefore, the ratios of providing the advertisements A, B and C for Mr. Kim are 3/5, 1/5 and 1/5, respectively.

The following is a description of processing a copied MP3 file that has been downloaded.

The devices such as a computer, a portable MP3 player, a wireless MP3 telephone set, etc. have original serial numbers of their own. To be specific, each computer has a serial number of its operating system, and each MP3 Player has a serial number. Each wireless MP3 telephone set has a serial number.

Such serial numbers can be used for determining whether or not the file currently being reproduced is a file copied from another device.

This means that a serial number of the first reproducing device is inserted to additional information part of the file at the time of first reproducing the file. Based on the inserted serial number, comparisons are made over the serial numbers of the devices currently reproducing the same file so as to determine whether the same file has ever been reproduced in the past and by the same device or whether the file has been copied from another device. If determined that the file is the one copied from another device, a proper manipulation can be made. For example, even if an advertisement has been reproduced for a certain number of times by one device, it is possible to make that the number of reproduced times can be recounted from the beginning after copying the file to a new device, or that the advertisement can be reproduced whenever an MP3 file is reproduced regardless of the number of reproduced times.

A direct downloading of a file by a user without copying the file can be induced by doing so.

The above description pertains to a case of providing a music service over internet according to a best mode 1 of the present invention. However, the available contents are not only music but also linguistic instructions as well.

As a best mode 2 of the present invention, the user may download an MP3 file over wireless internet by accessing the network with an internet phone. In that case, the process of downloading an MP3 file combined with an advertisement by a user is identical to that shown is FIG. 1.

The above examples are the cases of using an MP3 file as a multimedia file. However, the multimedia files are not limited to the MP3 files only but are extended to the files of any formats such as MP3, mp4, dat, avi, aac, ra, rm, mid, sgf, mov, mpg, vob, wav, rjs, dvd, ram, wma, asf, gif jpg, bmp, etc.

As a best mode 3 of the present invention, it is possible to add additional information to a multimedia file combined with an advertisement file. If the multimedia file is a music file, for example, the additional information is the information useful for reproducing the music file, such as a serial number, number of times to be reproduced, number of times reproduced, the first implemented date, a type of song, code number of the singer, sex of the singer, country code number, and the year when the song was published. The additional information may be variable depending on the format of a file. In particular, the additional information may be renewed whenever necessary be forming a reservation part for next services in the additional information region. Simultaneously providing additional information useful for who is downloading a multimedia file creates an effect of providing more diverse services for the user.

The above description pertains to a case of combining an advertisement file with a single thereof, it will be understood by those skilled in the art that various changes in form and details may be made therein without departing from the spirit and scope of the invention as defined by the appended claims.

As described above, a considerable amount of cost used to be incurred by a user when downloading a music file due to a copyright fee for the music. According to the present invention, however, an advertiser pays an advertisement fee to a music file provider in exchange of an advertisement combined with the music file. Since the copyright fee is compensated for by the advertisement fee, the music file provider can reduce the downloading cost for the user. As a consequence, the user can download music files at lower costs or free of charge without infringing copyrights. Ultimately, the cause of an illegal copying of files by the user can be eliminated, thereby serving to expanding a regular market.

Further, the advertisement fee paid by an advertiser is benefited by a home page administrator under the conventional advertisement method performed over internet. However, the home page administrator is able to reduce a file downloading cost in proportion to an advertisement fee paid by an advertiser. Therefore, not only the home page administrator but also the user can be financially benefited.

Also, the conventional advertisement method performed over internet such as a banner advertisement is limited to create a visual effect only including a static image or dynamic images displayed on a particular web page. However, the method according to the present invention enables a user not only to download and listen to an advertisement with a sound effect in real time (a streaming service) but also to repeatedly listen to the advertisement whenever listening to music, thereby creasing a high advertising effect.

The present invention also generates a new advertising medium by combining advertisement files with multimedia files and providing information services such as internet broadcasting available by paying fees or VOD or AOD of IMT-2000, which will be applicable in the future, free of charge or at low costs, thereby serving to create benefits to users, web site administrators and advertisers.

Moreover, the present invention has another advantage of effectively reproducing advertisements without boring the users by limiting the number of reproducing times or the period of reproducing time to a predetermined level and allowing reproduction of multimedia files only including music or image files without reproducing the advertisements thereafter.

What is claimed is:

1. A method for providing multimedia files in response to a request by a user over internet, comprising the step of:
determining a propensity of the user based on a multimedia file requested by the user;
selecting an advertisement file based on the propensity of the user and information on the user, and combining the advertisement file with the multimedia file requested by the user; and
providing the combined file with the user.

2. The method of claim 1, wherein the multimedia file include a music file, a voice file, an image file or a dynamic image file.

3. The method of claim 1, wherein the advertisement file includes a sound file, a character file, an image file or dynamic image file.

4. The method of claim 1, wherein the propensity of the user is determined in accordance with the reference representing characteristics of contents of the multimedia file requested by the user including a genre, year of production, a name of a composer, or a name of a singer.

5. The method of claim 1, wherein the information on the user includes sex, age, address, talents, hobbies and interest of the user.

6. The method of claim 1, further comprising a step of downloading the multimedia file combined with the advertisement file by the user.

7. The method of claim 6, characterized by reproducing the advertisement file with streaming while downloading the multimedia file combined with the advertisement file by the user.

8. The method of claim 6, further comprising a step of reproducing the downloaded file by means of a reproducing device including a portable reproducing device or a computer by the user.

9. The method of claim 7 or 8, characterized in that a uniform resource locator (URL) related to the advertisement file is displayed while the advertisement file contained in the downloaded file is reproduced.

10. The method of claim 7 or 8, comprising a step of inserting information on the reproducing device to the downloaded file when the advertisement file contained in the downloaded file is first reproduced.

11. The method of claim 10, characterized by reproducing the advertisement file contained in the downloaded file when the downloaded file is reproduced by another reproducing device by reference to the information on the original reproducing device.

12. The method of claim 10 or 11, wherein the information on the reproducing device includes a serial number thereof.

13. The method of claim 8, characterized in that the multimedia file only is reproduced without reproducing the advertisement file if the downloaded file has been reproduced a predetermined number of times or for a predetermined period of time.

14. The method of claim 13, further comprising a step of including information on a number of reproduced times of the advertisement file in a header of the multimedia file so as to reproduce the advertisement file a predetermined number of times only.

15. The method of claim 13, further comprising a step of including a reproducing period of time in a header of the multimedia file so as to reproduce the advertisement file for a predetermined period of time only.

16. The method of claim 13, characterized by deleting the advertisement file after reproduction thereof a predetermined number of times or for a predetermined period of time.

17. The method of claim 13, further comprising a step of calculating a number of times provided for the user with respect to each multimedia file to generate an order of providing multimedia files.

18. The method of claim 17, characterized by providing an order of providing multimedia files for advertisers, disc production companies or broadcasting companies.

19. The method of claim 1, wherein the selection of an advertisement file performed by reference to an account settling period, quantity and target of advertisements.

20. A method for providing multimedia files in response to a request by a user over internet, comprising the step of:
analyzing a propensity of the user based on a multimedia file requested by the user;
selecting an advertisement file based on the propensity of the user and information on the user, and combining the advertisement file with the multimedia file requested by the user;
adding information for the user to the combined file; and
providing the combined file containing the added information for the user.

21. The method of claim 20, wherein the information for the user includes a serial number, number of times to be reproduced, number of times reproduced up to the present, code number of a singer, sex of the singer, country code number, the year when the song was published, and the first implemented date.

22. The method of claim 1 or 20, wherein the internet is accessed to wirelessly.
